(19) United States
(12) Patent Application Publication
(10) Pub. No.: US 2023/0250999 A1
(43) Pub. Date: Aug. 10, 2023

(54) EXOTHERMIC REACTION APPARATUS AND METHOD FOR GENERATING EXCESSIVE HEAT

(71) Applicant: TECHNOVA INC., Tokyo (JP)

(72) Inventors: Akito TAKAHASHI, Tokyo (JP); Masahiko HASEGAWA, Tokyo (JP); Yutaka MORI, Tokyo (JP)

(73) Assignee: TECHNOVA INC., Tokyo (JP)

(21) Appl. No.: 18/163,947

(22) Filed: Feb. 3, 2023

(30) Foreign Application Priority Data
Dec. 8, 2021 (JP) 2021-199609

(51) Int. Cl. F24V 30/00; G05D 7/06

(52) U.S. Cl. CPC F24V 30/00; G05D 7/0635

(57) ABSTRACT

An exothermic reaction apparatus includes a reactor capable of accommodating a nanocomposite metal material, a cutoff unit provided in a gas pipe to cut off a supply of hydrogen to the reactor, a measurement unit that measures an occlusion rate of hydrogen in the nanocomposite metal material accommodated in the reactor, and a controller that controls the exothermic reaction apparatus. The controller controls the occlusion rate of hydrogen in the nanocomposite metal material accommodated in the reactor to a value within a range of 1.0 or more and 3.5 or less by controlling the cutoff unit during an exothermic reaction to stop the supply of hydrogen into the reactor when the occlusion rate of hydrogen in the nanocomposite metal material based on a measurement result obtained with the measurement unit approaches a predetermined value and to resume the supply of hydrogen into the reactor a predetermined time after.

### CROSS-REFERENCE TO RELATED APPLICATIONS

This application is based upon and claims the benefit of priority from Japanese Patent Application No. 2021-199609, filed on Dec. 8, 2021; the entire contents of which are incorporated herein by reference.

### FIELD

Embodiments of the present invention relate to an exothermic reaction apparatus and a method for generating excessive heat.

### BACKGROUND

There is a technique of using a nanocomposite metal material for an exothermic reaction with hydrogen. In this technique, heating the nanocomposite metal material after allowing the material to occlude hydrogen gas can cause an exothermic reaction. The nanocomposite metal material that has completed the exothermic reaction can occlude hydrogen gas again and increase the calorific value, for example by being subjected to refiring in the atmosphere after being taken out from a container for performing the exothermic reaction.

### SUMMARY

An exothermic reaction apparatus including a reactor capable of accommodating a nanocomposite metal material, a plurality of heating bodies that heat the nanocomposite metal material accommodated in the reactor, an exhaust unit that exhausts the inside of the reactor, a gas pipe having an upstream end connected to a hydrogen supply source and a downstream end connected to the reactor to supply hydrogen to the reactor, a cutoff unit provided in the gas pipe to cut off the supply of hydrogen to the reactor, a measurement unit that measures an occlusion rate of hydrogen in the nanocomposite metal material accommodated in the reactor, and a controller that controls the exothermic reaction apparatus, wherein the controller controls the occlusion rate of hydrogen in the nanocomposite metal material accommodated in the reactor to a value within a range of 1.0 or more and 3.5 or less by controlling the cutoff unit during an exothermic reaction to stop the supply of hydrogen into the reactor when the occlusion rate of hydrogen in the nanocomposite metal material based on a measurement result obtained with the measurement unit approaches a predetermined value and to resume the supply of hydrogen into the reactor a predetermined time after.

### BRIEF DESCRIPTION OF THE DRAWINGS

FIGS. 1A and 1B are schematic diagrams illustrating an example of a configuration of an exothermic reaction apparatus according to an embodiment;

FIG. 2 is a flowchart illustrating an example of a procedure of an excessive heat generation treatment according to an embodiment;

FIG. 3 is a schematic diagram illustrating an example of a method for producing a nanocomposite metal material according to an embodiment;

FIG. 4 is a flowchart illustrating an example of a procedure of a method for producing a nanocomposite metal material according to an embodiment;

FIG. 5 is a schematic diagram illustrating an example of a configuration of a nanocomposite metal material according to an embodiment;

FIG. 6 is a graph illustrating a representative example of a reaction response between a reactor central temperature and an excessive heat amount in an MHE reaction according to Example; and

FIGS. 7A and 7B are graphs illustrating an application example of a reactivation treatment of an exothermic reaction according to Example.

### DETAILED DESCRIPTION

Hereinafter, embodiments of the present invention will be described.

### Configuration Example of Exothermic Reaction Apparatus

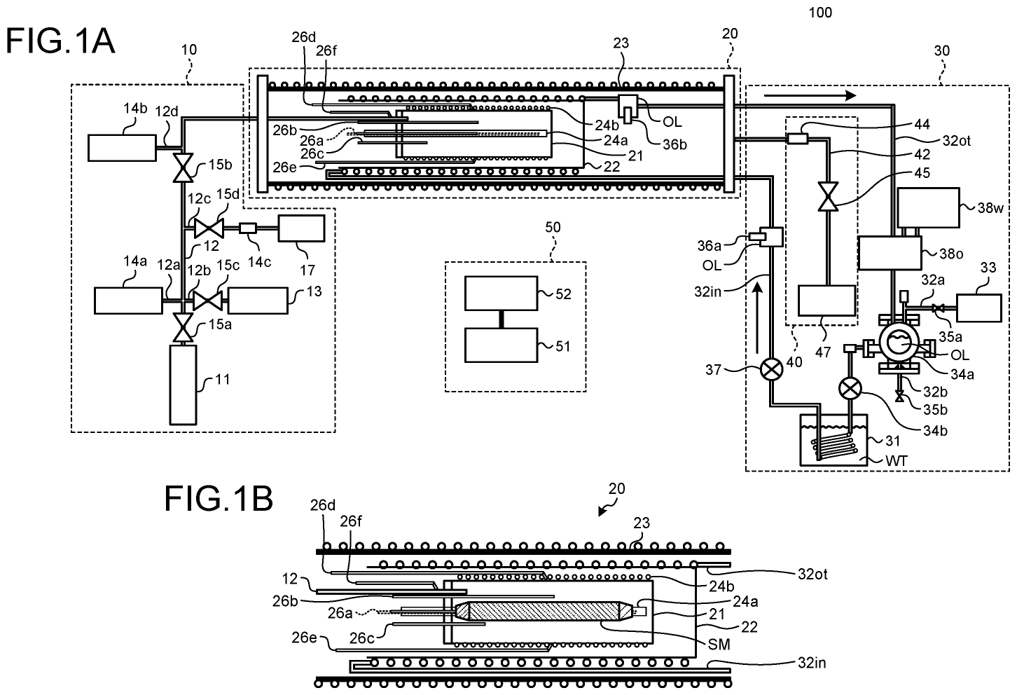

FIGS. 1A and 1B are schematic diagrams illustrating an example of a configuration of an exothermic reaction apparatus 100 according to an embodiment. FIG. 1A is a diagram illustrating the whole of the exothermic reaction apparatus 100 of the embodiment. FIG. 1B is a partially enlarged view of a housing 23 included in the exothermic reaction apparatus 100.

The exothermic reaction apparatus 100 is an apparatus that causes a nanocomposite metal material having, for example, a nanonickel core-copper shell structure to occlude hydrogen gas to cause an exothermic reaction and recovers generated heat. The recovered heat is used for hot water supply, heat supply, power generation, and the like.

As illustrated in FIG. 1A, the exothermic reaction apparatus 100 includes a hydrogen supply mechanism 10, an exothermic reaction mechanism 20, a circulation mechanism 30, an exhaust mechanism 40, and a control mechanism 50.

The hydrogen supply mechanism 10 includes a gas cylinder 11, a gas pipe 12, a tank 13, pressure gauges 14a and 14b, a vacuum gauge 14c, valves 15a to 15d, and a vacuum pump 17 and supplies hydrogen gas to the exothermic reaction mechanism 20.

An upstream end of the gas pipe 12 is connected to the gas cylinder 11 as a hydrogen supply source, and hydrogen gas such as deuterium gas or light hydrogen gas is supplied into a reactor 21 described later. A downstream end of the gas pipe 12 is connected to the reactor 21. The gas pipe 12 is provided with the valves 15a and 15b in order from upstream.

The gas pipe 12 has two branch pipes 12a and 12b branching downstream of the valve 15a. The pressure gauge 14a is connected to one branch pipe 12a, and the tank 13 is connected to the other branch pipe 12b via the valve 15c.

The pressure gauge 14a measures the pressure upstream of the valve 15b provided downstream of the gas pipe 12. The pressure measured by the pressure gauge 14a may be regarded as the pressure of hydrogen gas supplied from the hydrogen supply source side including the tank 13 described below.

The tank 13 temporarily stores surplus hydrogen. Opening and closing the valve 15c provided downstream of the tank 13 releases or stops releasing of hydrogen in the tank 13 to adjust the supply amount of hydrogen into the reactor 21 described later.

The gas pipe 12 has a branch pipe 12c branching further downstream of the branch pipes 12a and 12b. The vacuum pump 17 is connected to the branch pipe 12c via the valve 15d and the vacuum gauge 14c in order from the side closer to the gas pipe 12.

The vacuum gauge 14c is a pressure gauge capable of measuring a pressure less than the atmospheric pressure. Opening the valve 15d and operating the vacuum pump 17 while measuring the vacuum pressure with the vacuum gauge 14c can bring the pressure in the reactor 21 described later into a vacuum state. In this manner, the vacuum pump 17 functions as an exhaust unit that exhausts the inside of the reactor 21.

The gas pipe 12 has a branch pipe 12d branching downstream of the valve 15b, and the pressure gauge 14b is connected to the branch pipe 12d.

The pressure gauge 14b measures the pressure downstream of the valve 15b provided in the gas pipe 12. The pressure measured by the pressure gauge 14b may be regarded as the pressure on the reactor 21 side described later.

The exothermic reaction mechanism 20 includes the reactor 21, a heat recovery device 22, the housing 23, heating bodies 24a and 24b, and temperature sensors 26a to 26f and causes the nanocomposite metal material to occlude hydrogen gas to make an exothermic reaction.

The reactor 21 is a container made of stainless steel such as SUS304 or SUS316 and has a cylindrical shape with both ends closed, for example. A sample such as the nanocomposite metal material that causes an exothermic reaction can be accommodated in the reactor 21. The downstream end of the gas pipe 12 is connected to one end of the reactor 21. This can decompress the reactor 21 to a vacuum state with the vacuum pump 17 and can supply hydrogen gas from the gas cylinder 11 side to the reactor 21 side.

The reactor 21 is provided with the heating bodies 24a and 24b such as heaters. The heating body 24a is inserted into the reactor 21 along the central axis of the reactor 21. The heating body 24b is spirally wound around the outer wall of the body portion of the reactor 21.

As illustrated in FIG. 1B, a sample SM such as the nanocomposite metal material is loaded into the reactor 21 to cover the outer periphery of the heating body 24a. This causes the heating body 24a to directly heat the sample SM accommodated in the reactor 21. The heating body 24b heats the sample SM in the reactor 21 from the outside.

The temperature sensors 26a to 26f such as thermocouples are disposed in the reactor 21 and around the reactor 21.

The temperature sensors 26a to 26c are inserted into the reactor 21. Of these, the temperature sensor 26a is inserted into the heating body 24a and measures the central temperature of the sample SM loaded to cover the outer periphery of the heating body 24a. The temperature sensors 26b and 26c are disposed around the heating body 24a, each of which extends in the reactor 21 with a different length.

The temperature sensors 26d and 26e are provided on the outer wall of the body portion of the reactor 21 and measure the temperature of the outer wall of the reactor 21. The temperature sensor 26f is provided in the vicinity of the downstream end of the gas pipe 12 and measures the temperature of the gas pipe 12.

The heat recovery device 22 is made of stainless steel such as SUS304 or SUS316 and has, for example, a cylindrical shape with one end closed, the shape surrounding the reactor 21. The gas pipe 12 connected to one end of the reactor 21, the temperature sensors 26a to 26f provided to the reactor 21, and the like extend from the open one end of the heat recovery device 22.

Oil feed pipes 32in and 32ot described later are spirally wound around the outer wall of the body portion of the heat recovery device 22, and the heat generated from the sample SM in the reactor 21 is transferred to a circulating fluid OL flowing in the oil feed pipes 32in and 32ot because of the principle of heat exchange and is recovered.

The housing 23 is made of stainless steel such as SUS304 or SUS316 and has, for example, a cylindrical shape with both ends closed, the shape surrounding the heat recovery device 22. The gas pipe 12 described above penetrates one end of the housing 23 and is connected to the reactor 21.

An exhaust pipe 42 connected to a vacuum pump 47 described later is connected to the other end of the housing 23, with which the inside of the housing 23 can be brought into a vacuum state. Keeping, in this manner, the vacuum state inside the housing 23 surrounding the whole of the reactor 21 as a heat source reduces dissipation of the heat generated in the reactor 21 to the atmosphere through the housing 23.

The circulation mechanism 30 includes a water bus 31, the oil feed pipes 32in and 32ot, a storage unit 33, flowmeters 34a and 34b, valves 35a and 35b, temperature sensors 36a and 36b, a vacuum pump 37, an oil circulator 38o, and a water circulator 38w and circulates the circulating fluid OL to recover the heat generated from the reactor 21.

The water bus 31 is provided outside the housing 23, and it can store a coolant WT such as water.

The oil feed pipe 32in has an upstream end connected to a downstream end of the oil feed pipe 32ot in the coolant WT in the water bus 31, has a downstream end spirally wound around the outer wall of the body portion of the heat recovery device 22, and is connected to an upstream end of the oil feed pipe 32ot spirally wound around the outer wall of the body portion of the heat recovery device 22. That is, the upstream end of the oil feed pipe 32in is connected to the downstream end of the oil feed pipe 32ot, and the downstream end of the oil feed pipe 32in is connected to the upstream end of the oil feed pipe 32ot, whereby the oil feed pipe 32in and the oil feed pipe 32ot constitute an endless piping.

The circulating fluid OL such as oil circulates in the oil feed pipes 32in and 32ot. The oil feed pipe 32in is provided with the pump 37 downstream of the water bus 31, and the circulating fluid OL in the oil feed pipe 32in is delivered from the water bus 31 side to the heat recovery device 22 side. The circulating fluid OL recovers heat from the reactor 21 in the vicinity of the heat recovery device 22, turns back in the oil feed pipe 32ot, and is returned to the water bus 31 side. The heat recovered by the circulating fluid OL is delivered to the coolant WT in the water bus 31.

The temperature sensor 36a is provided downstream of the pump 37 of the oil feed pipe 32in. The temperature sensor 36a is configured as a thermocouple or the like and measures the temperature of the circulating fluid OL in the oil feed pipe 32in. The downstream end of the oil feed pipe 32in penetrates one end of the housing 23, is wound around the heat recovery device 22 as described above, and is connected to the downstream end of the oil feed pipe 32ot.

The upstream end of the oil feed pipe 32ot wound around the heat recovery device 22 penetrates one end of the housing 23. The temperature sensor 36b is provided on the near side of the end of the housing 23 of the oil feed pipe 32ot, that is, in a portion disposed inside the housing 23. The temperature sensor 36b is configured as a thermocouple or the like and measures the temperature of the circulating fluid OL in the oil feed pipe 32ot.

The oil circulator 38o is provided in a portion disposed downstream of the oil feed pipe 32ot and outside the housing 23. The oil circulator 38o is a temperature controller that adjusts the temperature of the circulating fluid OL circulating in the oil feed pipes 32in and 32ot. The water circulator 38w is connected to the oil circulator 380. The water circulator 38w is a temperature controller that adjusts the temperature of the coolant WT stored in the water bus 31.

The flowmeter 34a is provided on the oil feed pipe 32ot further downstream of the oil circulator 38o, and the flowmeter 34b is provided further downstream of the flowmeter 34a. Two branch pipes 32a and 32b of the oil feed pipe 32ot branch from the flowmeter 34a. The storage unit 33 is connected to the branch pipe 32a via the valve 35a. The branch pipe 32b is provided with the valve 35b.

The circulating fluid OL is stored in the storage unit 33. The flowmeters 34a and 34b respectively measure the flow rates of the circulating fluid OL passing through the flowmeters 34a and 34b based on the number of droplets.

The flowmeter 34b measures the flow rate of the circulating fluid OL flowing into the oil feed pipe 32ot of the portion immersed in the cooling water WT of the water bus 31. Based on the flow rate measured by the flowmeter 34b, the valves 35a and 35b is opened and closed appropriately, and the flow rate of the circulating fluid OL circulating in the oil feed pipes 32in and 32ot is increased or decreased.

That is, to increase the flow rate in the oil feed pipes 32in and 32ot, the valve 35a is opened to allow the circulating fluid OL in the storage unit 33 to newly flow into the oil feed pipe 32ot via the branch pipe 32a. To reduce the flow rate in the oil feed pipes 32in and 32ot, the valve 35b is opened to discharge a part of the circulating fluid OL in the oil feed pipe 32ot to the outside of the oil feed pipe 32ot via the branch pipe 32b.

The flowmeter 34b thus functions as an adjustment unit that adjusts the flow rate of the circulating fluid OL in the oil feed pipes 32in and 32ot.

The flowmeter 34a appropriately measures the flow rates of the circulating fluid OL flowing from the storage unit 33 into the oil feed pipe 32ot and the circulating fluid OL flowing out from the oil feed pipe 32ot to the outside, and it confirms that the flow rates of the circulating fluid OL in the oil feed pipes 32in and 32ot have been appropriately adjusted.

The exhaust mechanism 40 includes the exhaust pipe 42, a vacuum gauge 44, a valve 45, and the vacuum pump 47, and it exhausts the inside of the housing 23 to vacuum. The gas pipe 12, the vacuum gauge 14c, the valve 15d, and the vacuum pump 17 that exhaust the inside of the reactor 21 may be included in the exhaust mechanism 40.

As described above, one end of the exhaust pipe 42 is connected to the housing 23, and the other end is connected to the vacuum pump 47 via the vacuum gauge 44 and the valve 45 provided in order from upstream.

The vacuum gauge 44 is a pressure gauge capable of measuring a pressure less than the atmospheric pressure. Opening the valve 45 and operating the vacuum pump 47 while measuring the vacuum pressure with the vacuum gauge 44 can bring the pressure in the housing 23 into a vacuum state.

The control mechanism 50 includes a controller 51 and a data logger 52, and it controls the entire exothermic reaction apparatus 100.

The data logger 52 collects and stores the pressure of each unit measured by the pressure gauges 14a and 14b and the vacuum gauges 14c and 44, the temperature of each unit measured by the temperature sensors 26a to 26f, 36a, and 36b, the flow rate of the circulating fluid OL measured by the flowmeters 34a and 34b, and the like.

The controller 51 is configured as, for example, a personal computer (PC) including a central processing unit (CPU), a read only memory (ROM), and a random access memory (RAM).

The CPU (not illustrated) reads out a control program or the like stored in the ROM or the like, develops the control program or the like in the RAM, and executes the control program or the like, and thus a function as a control unit that controls each unit of the exothermic reaction apparatus 100 is realized in the controller 51.

The controller 51 controls each unit of the exothermic reaction apparatus 100, such as the vacuum pumps 17 and 47, the pump 37, the heating bodies 24a and 24b, the oil circulator 38o, the water circulator 38w, and the valves 15a to 15d, 35a, 35b, and 45 while referring to the measurement data collected by the data logger 52.

More specifically, the controller 51 controls the pressure in the housing 23 by operating the vacuum pump 47 based on the measurement result obtained with the vacuum gauge 44 while appropriately opening and closing the valve 45. The controller 51 controls the pressure in the reactor 21 by operating the vacuum pump 17 based on the measurement result obtained with the vacuum gauge 14c while appropriately opening and closing the valve 15d.

The controller 51 controls the supply start, the supply stop, and the supply amount of hydrogen gas into the reactor 21 by opening and closing the valves 15a to 15c based on the measurement result obtained with the pressure gauge 14b.

The controller 51 controls the exothermic reaction of the nanocomposite metal material in the reactor 21 by opening and closing the valve 15b based on the measurement results obtained with the pressure gauges 14a and 14b while grasping the state of the exothermic reaction in the reactor 21 based on the measurement results obtained with the temperature sensors 26a to 26f. A method for controlling the exothermic reaction of the nanocomposite metal material will be described later.

The controller 51 circulates the circulating fluid OL in the oil feed pipes 32in and 32ot by operating the pump 37. The controller 51 appropriately maintains the flow rate of the circulating fluid OL in the oil feed pipes 32in and 32ot by appropriately opening and closing the valves 35a and 35b based on the measurement result obtained with the flowmeter 34b. The controller 51 appropriately maintains the temperatures of the circulating fluid OL and the coolant WT with the oil circulator 38o and the water circulator 38w based on the measurement results obtained with the temperature sensors 36a and 36b.

Here, the nanocomposite metal material to be subjected to the exothermic reaction in the exothermic reaction apparatus 100 will be described below.

The nanocomposite metal material of the embodiment is a metal composite catalyst including, for example, a carrier made of ceramic and two-element metal particles supported on the carrier and containing copper (Cu) and nickel (Ni). The two-element metal particle is a metal nanoparticle having a nanonickel core-copper shell structure that is composed of two elements of copper and nickel. The nanoparticle has nickel as a core and has copper as a shell.

Such a nanocomposite metal material can occlude hydrogen into their metal nanoparticles with a supply of hydrogen gas. At this time, the ratio of the number of atoms of the occluded hydrogen to the number of atoms of nickel contained in the nanocomposite metal material (H/Ni or D/Ni) is referred to as a hydrogen occlusion rate. It is desirable that the nanocomposite metal material used in the exothermic reaction apparatus 100 of the embodiment can obtain a hydrogen occlusion rate of, for example, 1.0 or more, preferably about 3.5.

### Operation Example of Exothermic Reaction Apparatus

The above-described exothermic reaction apparatus 100 performs a heat treatment, a hydrogen occlusion treatment, an exothermic reaction treatment, and a reactivation treatment of exothermic reaction on the nanocomposite metal material to generate heat from the nanocomposite metal material. Hereinafter, an operation example of the exothermic reaction apparatus 100 of the embodiment will be described with reference to FIGS. 1A and 1B.

First, the sample SM such as the nanocomposite metal material is loaded into the reactor 21 of the exothermic reaction apparatus 100. That is, as illustrated in FIG. 1B, the sample SM is disposed to have a thickness of, for example, 1 mm or more and 20 mm or less and to cover the outer periphery of the heating body 24a in the reactor 21.

Next, the controller 51 operates the vacuum pumps 17 and 47 and opens the valves 15d, 15b, and 45. This decompresses the reactor 21 and the housing 23 surrounding the reactor 21 to a vacuum state. The pressure gauge 14b measures the pressure on the reactor 21 side and the measurement results are collected and recorded by the data logger 52.

The controller 51 starts the heat treatment of the sample SM when the pressure in the reactor 21 becomes, for example, less than 1 Pa from the measurement result obtained with the pressure gauge 14b recorded in the data logger 52. That is, the controller 51 heats the sample SM by causing the plurality of heating bodies 24a and 24b provided to the reactor 21 to generate heat.

The plurality of temperature sensors 26a to 26f provided to the reactor 21 measure temperatures in the reactor 21 and around the reactor 21. The data logger 52 collects and records the measurement results obtained with the temperature sensors 26a to 26f.

The controller 51 controls the heating bodies 24a and 24b such that the temperature of the heat treatment is within the range of, for example, 200° C. or more and 450° C. or less while referring to the measurement results obtained with the temperature sensors 26a to 26f recorded in the data logger 52. The temperature range of the heat treatment may be a range of 200° C. or more and 300° C. or less, a range of 250° C. or more and 400° C. or less, or a range of 200° C. or more and 500° C. or less.

At this time, the temperature distribution of the sample SM during heating is maintained in the range of 200° C. or more and 250° C. or less as a minimum temperature and is maintained in the range of 350° C. or more and 450° C. or less as a maximum temperature. In the period from the start time to the end time, the temperature is maintained in the temperature range from the minimum temperature of 200° C. or more and 250° C. or less to the maximum temperature of 350° C. or more and 450° C. or less.

The heating time in the heat treatment is, for example, preferably in the range of 10 hours or more and 72 hours or less, and more preferably in the range of 24 hours or more and 72 hours or less. The heating time may vary depending on the heating temperature. For example, when the heat treatment is performed at 300° C., the heating time is preferably in the range of 24 hours or more and 64 hours or less, and more preferably in the range of 48 hours or more and 64 hours or less.

After the predetermined time has elapsed, the controller 51 naturally cools the sample SM by stopping the heat generation of the heating bodies 24a and 24b. The controller 51 continues the operation of the vacuum pumps 17 and 47 even while cooling the sample SM and maintains the pressure in the reactor 21 at, for example, less than 1 Pa.

When it is confirmed from the measurement results obtained with the temperature sensors 26a to 26f recorded in the data logger 52 that the temperature of the sample SM is, for example, about the same as room temperature, the controller 51 starts the hydrogen occlusion treatment.

That is, the controller 51 opens the valves 15a and 15c to supply hydrogen gas from the gas cylinder 11 to the tank 13 for storage. When the required amount of hydrogen gas is stored in the tank 13, the controller 51 closes the valve 15a to disconnect the gas cylinder 11 from the hydrogen supply line. The controller 51 opens the valve 15b to supply hydrogen gas from the tank 13 into the reactor 21. The gas pressure of the hydrogen gas supplied into the reactor 21 may be 0.5 MPa or more and 1 MPa or less. The pressure gauge 14a measures the pressure on the hydrogen supply source side including the tank 13, and the measurement results are collected and recorded by the data logger 52.

The controller 51 refers to the measurement results obtained with the pressure gauges 14a and 14b recorded in the data logger 52 and appropriately opens and closes the valve 15c to adjust the pressure in the reactor 21 using the function of the tank 13 as an accumulator.

This causes a reaction between the sample SM and hydrogen at room temperature under vacuum, and hydrogen gas is occluded in the sample SM which is a nanocomposite metal material. The treatment time of the hydrogen occlusion treatment depends on the progress of hydrogen occlusion into the sample SM, but is preferably, for example, in the range of 24 hours or more and 48 hours or less.

The progress of hydrogen occlusion may be recognized, for example, by monitoring the measurement results obtained with the pressure gauges 14a and 14b. That is, for example, the supply amount of hydrogen gas to the reactor 21 may be determined from the measurement result obtained with the pressure gauge 14a. As the occlusion of hydrogen gas into the sample SM progresses, the gas pressure of the hydrogen gas in the reactor 21 decreases. Thus, for example, a pressure change in the reactor 21 may be recognized from the measurement result obtained with the pressure gauge 14b, and the amount of hydrogen gas occluded in the sample SM may be recognized based on the pressure change.

The treatment time of the hydrogen occlusion treatment is determined normally based on the hydrogen occlusion rate calculated from the hydrogen gas occlusion amount and the amount of nickel contained in the sample SM loaded in the reactor 21.

When it is determined that the hydrogen occlusion rate in the sample SM has reached a desired value based on the measurement results obtained with the pressure gauges 14a and 14b recorded in the data logger 52, the controller 51 starts the exothermic reaction treatment.

That is, the controller 51 heats the sample SM by causing the plurality of heating bodies 24a and 24b to generate heat while continuing the supply of hydrogen gas into the reactor 21 in the vacuum state. The controller 51 controls the heating bodies 24a and 24b such that the temperature in the reactor 21 is within the range of, for example, 250° C. or more and 450° C. or less while referring to the measurement results obtained with the temperature sensors 26a to 26f recorded in the data logger 52.

Specifically, the temperature distribution of the sample SM during heating is maintained in the range of 200° C. or more and 250° C. or less as a minimum temperature and is maintained in the range of 350° C. or more and 450° C. or less as a maximum temperature.

This causes an exothermic phenomenon due to the reaction between the nanocomposite metal material and hydrogen. This exothermic phenomenon may be referred to as an abnormal exothermic phenomenon. Such an exothermic reaction is called a metal hydrogen energy (MHE) reaction. Hereinafter, such a reaction is also referred to as an MHE reaction.

In the MHE reaction, the nanocomposite metal material is heated by the heating bodies 24a and 24b, whereby endothermic occlusion of hydrogen into the nanocomposite metal material occurs and at least part of hydrogen is released. During the hydrogen occlusion and releasing, an exothermic site forming hydrogen clusters is formed on the surface of the incomplete core-shell structure in which the nickel core is incompletely covered with copper. In addition, an exothermic reaction MHE occurs at the nickel core T sites because of induction of internal hydrogen clusters due to phonon excitation caused under temperature rise in a state where the O-sites of the nickel core lattice are filled with hydrogen. (Non-Patent Literatures 1 and 2 below)

[Non-Patent Literature 1] A. Takahashi, Y. Miyoshi, H. Sakoh, A. Taniike, A. Kitamura, R. Seto, and Y. Fujita, Mesoscopic Catalyst and D-Cluster Fusion, Proc. JCF 11 (2011) 47-52

[Non-Patent Literature 2] A. Takahashi, Are Ni+H Nuclear Reactions Possible?, 10th Int. Workshop on Anomalies in Hydrogen Loaded Metals, Siena Italy, 2012, JCMNS 9 (2012)

The supply of hydrogen gas is continued during this period. Thus, during the MHE reaction, it is considered that the process in which continuously supplied hydrogen gas is newly occluded and the process in which hydrogen is released compete with each other on the surface of the nickel core, whereby the exothermic reaction is continued.

Hereinafter, the heat generated by the MHE reaction is also referred to as excessive heat. The excessive heat is calculated as a value obtained by subtracting the calorific values of the heating bodies 24a and 24b from the internal temperature of the sample SM measured by, for example, the temperature sensors 26a to 26f.

The controller 51 operates the pump 37 of the circulation mechanism 30 to circulate the circulating liquid OL in the oil feed pipes 32in and 32ot. As a result, in the heat recovery device 22 surrounding the reactor 21, excessive heat generated in the reactor 21 is transferred to the circulating fluid OL by heat exchange, further transferred to the coolant WT in the water bus 31, and taken out to the outside of the exothermic reaction apparatus 100.

During this time, the controller 51 appropriately opens and closes the valves 35a and 35b based on the measurement result obtained with the flowmeter 34b to adjust the flow rate of the circulating fluid OL in the oil feed pipe 32ot. The controller 51 controls the oil circulator 38o and the water circulator 38w based on the measurement results obtained with the temperature sensors 36a and 36b to adjust the temperatures of the circulating fluid OL and the coolant WT.

Here, it is considered that the hydrogen occlusion rate in the nanocomposite metal material is less than 1.0 until the O-sites of the nickel core are filled at the beginning when the temperature rise by the heating bodies is started. Thus, as the temperature rise progresses, the hydrogen occlusion rate increases, and when the occlusion rate becomes, for example, 1.0 or more, the MHE reaction excessive heat generated by the nanocomposite metal material at the nickel core T sites increases because of induction of internal hydrogen clusters due to phonon excitation under temperature rise in a state where the O-sites of the nickel core lattice are filled with hydrogen. (Non-Patent Literatures 1 and 2)

On the other hand, it is considered that when the hydrogen occlusion rate in the nanocomposite metal material exceeds, for example, 2.0, the hydrogen releasing process and the occlusion process antagonize each other, and the occlusion speed of hydrogen gas into the nanocomposite metal material decreases. The excessive heat generated by the nanocomposite metal material also decreases accordingly.

In this manner, it may be estimated from the measurement results obtained with the pressure gauges 14a and 14b that the hydrogen occlusion rate approaches, for example, 2.0 to 3.5 and the occlusion speed of hydrogen gas into the nanocomposite metal material is decreased. That is, initially, hydrogen gas is actively occluded in the nanocomposite metal material, and the pressure on the hydrogen supply source side and the pressure on the reactor 21 side both decrease. When the occlusion speed of hydrogen gas decreases, the pressures on the hydrogen supply source side and the reactor 21 side become substantially constant.

When it is estimated that the pressures on the hydrogen supply source side and the reactor 21 side are both substantially constant and the hydrogen occlusion rate approaches, for example, 2.0 to 3.5, the controller 51 performs reactivation treatment of the exothermic reaction to promote the MHE reaction. The reactivation treatment of the exothermic reaction is performed by stopping the supply of hydrogen gas to the reactor 21 for a predetermined period and then resuming the supply.

That is, the controller 51 closes the valve 15b and temporarily stops the supply of hydrogen gas to the reactor 21. The valve 15b is closed at a timing when the hydrogen occlusion rate in the nanocomposite metal material based on the measurement results obtained with the pressure gauges 14a and 14b is, for example, within the range of 1.0 or more and 3.5 or less, preferably 1.5 or more and 3.0 or less.

Here, even after the valve 15b is closed and the supply of the hydrogen gas is cut off, the hydrogen gas supplied so far remains in the reactor 21. Thus, the reaction between the sample SM and hydrogen continues after the valve 15b is closed, and hydrogen gas continues to be occluded into the nanocomposite metal material.

As a result, while the pressure on the hydrogen supply source side, which is the measurement result obtained with the pressure gauge 14a, is kept substantially constant, the pressure on the reactor 21 side, which is the measurement result obtained with the pressure gauge 14b, decreases, and the pressure difference between the hydrogen supply source side and the reactor 21 side increases.

When the differential pressure between the hydrogen supply source side and the reactor 21 side falls within the range of, for example, 5 kPa or more and 200 kPa or less, preferably 20 kPa or more and 100 kPa or less, the controller 51 opens the valve 15b and resumes the supply of hydrogen gas to the reactor 21.

In this manner, opening the valve 15b in a state where the pressure difference between the hydrogen supply source side and the reactor 21 side is large causes hydrogen gas to flow into the reactor 21 at a high speed and the pressure on the reactor 21 side to rapidly increase. The rapid increase of the pressure on the side of the reactor 21 increases the probability of collision of hydrogen with the nanocomposite metal material, and the MHE reaction due to the increase in hydrogen cluster formation on the surface of the nanocomposite metal material is promoted to generate an exothermic trigger. The heat generation trigger causes part of hydrogen held at the T sites of the nickel core to be released, and the occlusion rate is reduced by about 0.05 to 0.2. Then, hydrogen is slowly occluded in and replenished to vacant T sites, and the occlusion rate increases to, for example, 2.0 or more. In this process, hydrogen clusters due to phonon excitation are formed at the T sites, and the MHE reaction increases. The decreased excessive heat can be thus recovered (Non-Patent Literature 1).

The reactivation treatment of the exothermic reaction as described above may be repeatedly performed a plurality of times during the exothermic reaction treatment. This controls the hydrogen occlusion rate of the nanocomposite metal material during the exothermic reaction treatment into the range of, for example, 1.0 or more and 3.5 or less. The exothermic reaction treatment is continued, for example, for 3 days or more and 7 days or less while the reactivation treatment of the exothermic reaction is performed at least once, or preferably repeated intermittently a plurality of times.

With that, the operations of the heat treatment, the hydrogen occlusion treatment, the exothermic reaction treatment, and the reactivation treatment of the exothermic reaction by the exothermic reaction apparatus 100 of the embodiment end.

As described above, in the exothermic reaction apparatus 100 of the embodiment, the controller 51 performs various operations mainly based on the measurement results obtained with the pressure gauges 14a and 14b. At this time, the pressure gauges 14a and 14b function as a measurement unit that measures the hydrogen occlusion rate in the nanocomposite metal material. The valve 15b sandwiched between the pressure gauges 14a and 14b functions as a cutoff unit that cuts off the supply of hydrogen to the reactor 21.

However, in addition to the measurement results obtained with the pressure gauges 14a and 14b, when it is possible to measure the hydrogen occlusion rate in the nanocomposite metal material based on other physical amounts in the exothermic reaction apparatus 100, the controller 51 may perform the above various operations based on the measurement results of such physical quantities.

As an example, when it is found that the excessive heat has decreased from the measurement results obtained with the temperature sensors 26a to 26f provided to the reactor 21, it is possible to estimate that the hydrogen occlusion rate in the nanocomposite metal material has reached around 2.0 to 3.5. Thus, for example, the temperature sensors 26a to 26f may also function as a measurement unit that measures the hydrogen occlusion rate in the nanocomposite metal material.

As another example, when the time from the closing of the valve 15b until the differential pressure between the hydrogen supply source side and the reactor 21 side reaches a desired value is measured in advance, the time from the closing of the valve 15b can be measured, and the timing to open the valve 15b can be measured.

In this manner, in the exothermic reaction apparatus 100 of the embodiment, at least one of the pressure gauges 14a and 14b, the temperature sensors 26a to 26f, and a timing mechanism (not illustrated), or a combination of at least some of them may be caused to function as a measurement unit that measures the hydrogen occlusion rate in the nanocomposite metal material. The controller 51 may perform the above-described various operations based on these measurement results.

### Method for Generating Excessive Heat

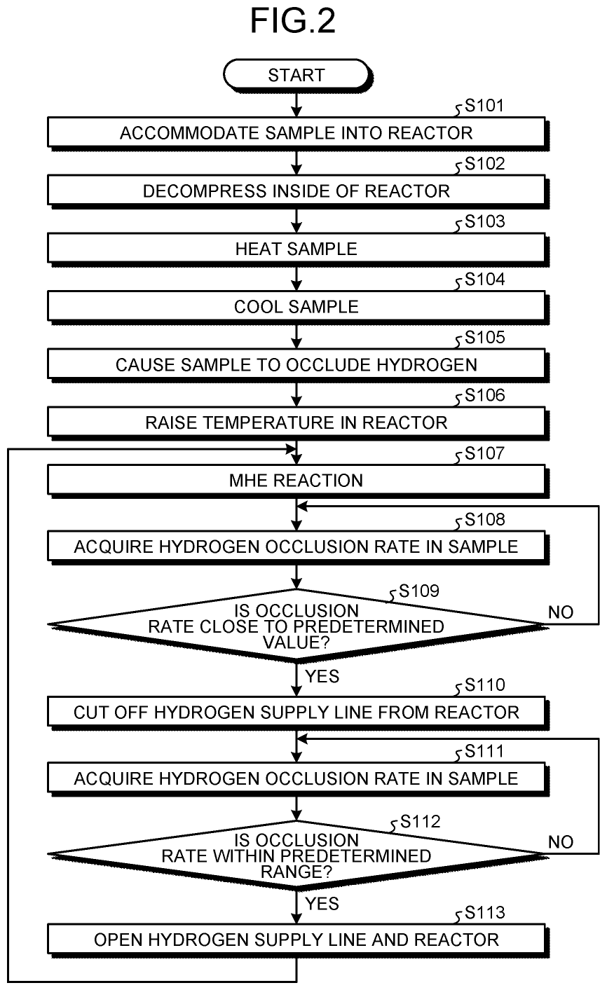

Next, an example of an excessive heat generation method performed in the exothermic reaction apparatus 100 of the embodiment will be described with reference to FIG. 2. FIG. 2 is a flowchart illustrating an example of a procedure of an excessive heat generation treatment according to the embodiment.

As illustrated in FIG. 2, accommodate the sample SM such as the nanocomposite metal material with a thickness of, for example, 1 mm or more and 30 mm or less into the reactor 21 of the exothermic reaction apparatus 100 (Step S101).

Next, operate the vacuum pump 17 to decompress the inside of the reactor 21 to, for example, less than 1 Pa (Step S102). In addition, operate the vacuum pump 47 to decompress the housing 23 surrounding the reactor 21 to vacuum.

When the inside of the reactor 21 is in a vacuum state of less than 1 Pa, heat the sample SM accommodated in the reactor 21 with the heating bodies 24a and 24b provided to the reactor 21 (Step S103). This heat treatment is performed, for example, at a temperature of 200° C. or more and 450° C. or less for 10 hours or more and 72 hours or less.

After the predetermined time has elapsed, stop the heating of the sample SM with the heating bodies 24a and 24b and naturally cool the sample SM until the temperature of the sample SM becomes, for example, about the same as room temperature (Step S104).

When the sample SM is cooled to a predetermined temperature, supply hydrogen gas into the reactor 21 in a vacuum state and cause the sample SM to occlude the hydrogen gas (Step S105). The gas pressure of the hydrogen gas supplied into the reactor 21 is, for example, 0.5 MPa or more and 1 MPa or less. The hydrogen occlusion treatment is performed, for example, for 24 hours or more and 48 hours or less.

When the hydrogen gas is occluded and the hydrogen occlusion rate in the sample SM reaches a desired value, raise the temperature in the reactor 21 with the heating bodies 24a and 24b while maintaining the supply of hydrogen gas into the reactor 21 (Step S106). At this time, the temperature in the reactor 21 is set to, for example, 250° C. or more and 450° C. or less. An MHE reaction between the sample SM and hydrogen thus occurs (Step S107).

When the MHE reaction occurs and the exothermic reaction treatment is started, acquire the hydrogen occlusion rate in the sample SM (Step S108) and determine whether the hydrogen occlusion rate is close to, for example, 1.0 or more and 3.5 or less, preferably 1.5 or more and 3.0 or less (Step S109). When there is still a margin until the hydrogen occlusion rate reaches the predetermined value (Step S109: No), continue the acquisition of the hydrogen occlusion rate (Step S108).

When the hydrogen occlusion rate is close to the predetermined value (Step S109: Yes), cut off the hydrogen supply line including the gas cylinder 11, the tank 13, and the gas pipe 12 from the reactor 21 (Step S110). This temporarily stops the supply of hydrogen gas into the reactor 21.

After the hydrogen supply line and the reactor 21 are cut off, acquire the hydrogen occlusion rate in the sample SM (Step S111) and determine whether the reaction between the sample SM and hydrogen has progressed and the hydrogen occlusion rate has reached a desired value (Step S112).

Whether the hydrogen occlusion rate has reached a desired value may be determined by, for example, the differential pressure between the pressure gauges 14a and 14b provided in the hydrogen supply line. When the differential pressure between the pressure gauges 14a and 14b is, for example, 5 kPa or more and 200 kPa or less, preferably 20 kPa or more and 100 kPa or less, it is estimated that the hydrogen occlusion rate has reached a desired value.

For example, when the hydrogen occlusion rate based on the differential pressure between the pressure gauges 14a and 14b or the like is not a desired value (Step S112: No), continue the acquisition of the hydrogen occlusion rate (Step S111).

When the hydrogen occlusion rate is a desired value (Step S112: Yes), open the hydrogen supply line and the reactor 21 (Step S113). This resumes the supply of hydrogen gas into the reactor 21.

Thereafter, repeat the treatment from Steps S107 to S113. By performing the exothermic reaction treatment including the reactivation treatment of the exothermic reaction in Steps S108 to S113 in this manner, the hydrogen occlusion rate of the sample SM is controlled to, for example, 1.0 or more and 3.5 or less during the exothermic reaction treatment. The exothermic reaction treatment is performed, for example, for 3 days or more and 7 days or less.

With that, the excessive heat generation treatment of the embodiment ends.

### Example of Nanocomposite Metal Material

As described above, the nanocomposite metal material of the embodiment has a structure in which, for example, a two-element metal particle having a nanonickel core-copper shell structure are supported on a ceramic carrier. Such a nanocomposite metal material is produced, for example, as follows.

First, fine metal particles are generated through a treatment by a melt spinning method and an oxidation treatment by heating using, as raw materials, two-element metal particles and an alloy of a plurality of kinds of metals to be contained in a carrier. The fine metal particles are subjected to a firing treatment, a heat treatment, a hydrogen occlusion treatment, an exothermic reaction treatment, and a refiring treatment to obtain a nanocomposite metal material.

Alternatively, a nanocomposite metal material produced by further repeatedly performing the heat treatment, the hydrogen occlusion treatment, the exothermic reaction treatment, and the refiring treatment on the nanocomposite metal material obtained as described above may be used for the exothermic reaction in the exothermic reaction apparatus 100.

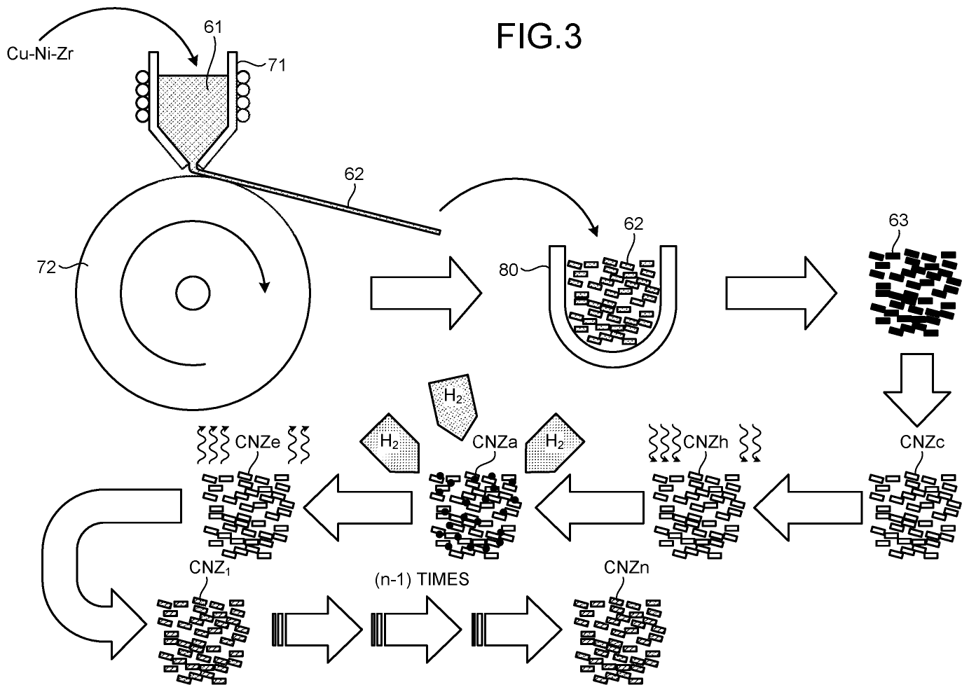

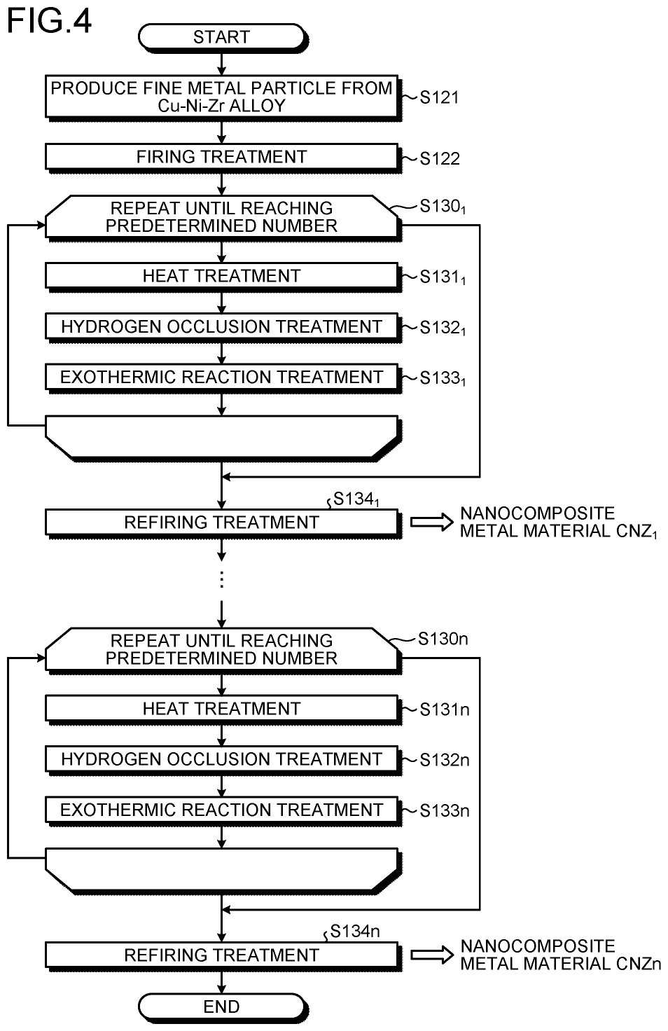

Hereinafter, a method for producing nanocomposite metal materials CNZ₁ . . . CNZn used in the exothermic reaction in the exothermic reaction apparatus 100 will be described with reference to FIGS. 3 and 4. In the following example, a case where zirconia (ZrO₂) ceramic is used as the carrier will be described.

FIG. 3 is a schematic diagram illustrating an example of a method for producing nanocomposite metal materials CNZ₁ . . . CNZn according to the embodiment.

As illustrated in FIG. 3, melt a Cu—Ni—Zr alloy 61 by a melt spinning method (melt quenching method) and quench it to produce an amorphous metal 62. The melt spinning method is a method in which an alloy melted at a high temperature is rapidly cooled in a time shorter than a time required for crystallization to obtain an amorphous metal.

That is, melt the Cu—Ni—Zr alloy 61 by heating it in a heating furnace 71 then blow the molten liquid onto the surface of a cooling roller 72 rotating at a high speed. The molten liquid is solidified by coming into contact with the cooling roller 72 rotating at a high speed, and the amorphous metal 62 having a ribbon shape is generated. The thickness of the ribbon-shaped amorphous metal 62 is adjusted to a thickness range of, for example, 5 μm or more and 50 μm or less by adjusting the supply amount to the cooling roller 72, the rotation speed of the cooling roller 72, and the like.

Next, perform an oxidation treatment on the amorphous metal 62 in the atmosphere. That is, for example, put the amorphous metal 62 into a crucible 80 and heat it at a temperature of 400° C. or more and 600° C. or less for 100 hours or more and 200 hours or less. The amorphous metal 62 is thus oxidized. By this oxidation treatment, zirconium (Zr) is oxidized and zirconia (ZrO₂) is obtained.

Next, perform a pulverization treatment for pulverizing the oxidized amorphous metal 62 to obtain fine metal particles 63. For the pulverization treatment, for example, an automatic mortar treatment in which at least either a mortar or a pestle is automatically rotated may be used. The volume average particle diameter of the fine metal particles 63 preferably includes at least the range of 0.05 mm or more and 0.3 mm or less.

Next, bake the fine metal particles 63 in the atmosphere to obtain the nanocomposite metal material CNZc. Hereinafter, the baking treatment in the atmosphere may also be referred to as a firing treatment.

In the firing treatment, the temperature of the fine metal particles 63 is maintained in the range of 300° C. or more and 600° C. or less. The temperature in the firing treatment is preferably in the range of 400° C. or more and 500 ° C. or less, more preferably in the range of 450° C. or more and 500° C. or less, and may be set to, for example, 450° C. The time of the firing treatment is preferably in the range of 120 hours or more and 180 hours or less.

By the above-described firing treatment, the fine metal particles 63 are chemically modified, and two-element metal particles having a nanonickel core-copper shell structure are in a state of being adhered or fused to the inside and the surface of the carrier of zirconia ceramic.

Next, perform a heat treatment on the nanocomposite metal material CNZc. The nanocomposite metal material CNZh is thus obtained.

The heat treatment on the nanocomposite metal material CNZc may be performed under the same conditions as those of the above-described heat treatment using the above-described exothermic reaction apparatus 100, for example. That is, for example, perform the heat treatment on the nanocomposite metal material CNZc at a temperature of 200° C. or more and 450° C. or less for 10 hours or more and 72 hours or less under a vacuum condition of less than 1 Pa.

Next, perform a hydrogen occlusion treatment on the nanocomposite metal material CNZh after the heat treatment. The nanocomposite metal material CNZa is thus obtained.

The heat treatment on the nanocomposite metal material CNZh may be subsequently performed under the same conditions as those of the above-described hydrogen occlusion treatment using the above-described exothermic reaction apparatus 100, for example. That is, in a vacuum state and at room temperature, supply hydrogen gas having a gas pressure of, for example, 0.5 MPa or more and 1 MPa or less to the nanocomposite metal material CNZh and perform the hydrogen occlusion treatment for 24 hours or more and 48 hours or less.

Next, raise the temperature of the nanocomposite metal material CNZa occluding hydrogen to perform an exothermic reaction treatment. The nanocomposite metal material CNZe is thus produced.

The exothermic reaction treatment on the nanocomposite metal material CNZa may be subsequently performed under the same conditions as those of the above-described exothermic reaction treatment using the above-described exothermic reaction apparatus 100, for example. That is, while the supply of hydrogen gas to the nanocomposite metal material CNZa is maintained, raise the temperature to, for example, 250° C. or more and 450° C. or less under vacuum conditions and cause the MHE reaction between the nanocomposite metal material CNZa and hydrogen. The exothermic reaction treatment is performed, for example, for 3 days or more and 7 days or less.

The heat treatment, the hydrogen occlusion treatment, and the exothermic reaction treatment described above may be repeatedly performed a plurality of times.

Next, perform a refiring treatment on the nanocomposite metal material CNZe. The nanocomposite metal material CNZ₁ is thus produced.

The refiring treatment is a baking treatment performed in the atmosphere, and the treatment is performed under the same conditions as those of the firing treatment described above. That is, heat the nanocomposite metal material CNZe at a temperature of 300° C. or more and 600° C. or less for 120 hours or more and 180 hours or less, for example. The nanocomposite metal material CNZ₁ of the embodiment is thus produced.

As described above, a treatment in which the heat treatment, the hydrogen occlusion treatment, and the exothermic reaction treatment are performed a predetermined number of times, and then the refiring treatment is performed once may be repeated a predetermined number of times to produce the nanocomposite metal material CNZn of the embodiment.

That is, the nanocomposite metal material CNZ₁ of the embodiment is a nanocomposite metal material produced by performing the heat treatment, the hydrogen occlusion treatment, and the exothermic reaction treatment a predetermined number of times, and further performing the refiring treatment once on the nanocomposite metal material CNZe obtained by firing the fine metal particles 63. The nanocomposite metal material CNZn of the embodiment is a nanocomposite metal material produced by repeating n times a treatment of performing the heat treatment, the hydrogen occlusion treatment, and the exothermic reaction treatment a predetermined number of times, and further performing the refiring treatment once on the nanocomposite metal material CNZe obtained by firing the fine metal particles 63.

FIG. 4 is a flowchart illustrating an example of a procedure of a method for producing the nanocomposite metal materials CNZ₁ . . . CNZn according to the embodiment.

As illustrated in FIG. 4, produce the fine metal particles 63 from the Cu—Ni—Zr alloy 61 (Step S121). That is, as described above, produce the amorphous metal 62 from the Cu—Ni—Zr alloy 61 by a melt spinning method. Perform an oxidation treatment on the amorphous metal 62 in the atmosphere, then perform a pulverization treatment to produce the fine metal particles 63.

Next, perform a firing treatment on the fine metal particles 63 in the atmosphere at a temperature of 300° C. or more and 600° C. or less for 120 hours or more and 180 hours or less, for example (Step S122). The nanocomposite metal material CNZc as a first product is thus produced.

Next, repeat the heat treatment (Step S131₁), the hydrogen occlusion treatment (Step S132₁), and the exothermic reaction treatment (Step S133₁) in this order until the number of times reaches a predetermined number (Step S130₁). The number of times of performing these treatments may be one cycle or a plurality of cycles.

That is, in the heat treatment (Step S131₁), the nanocomposite metal material CNZc is heated at a temperature of, for example, 200° C. or more and 450° C. or less for 10 hours or more and 72 hours or less under a vacuum condition of less than 1 Pa. The nanocomposite metal material CNZh as a second product is thus produced.

In the hydrogen occlusion treatment (Step S132₁), hydrogen gas having a gas pressure of, for example, 0.5 MPa or more and 1 MPa or less is supplied in a vacuum state at room temperature, and the hydrogen gas is occluded in the nanocomposite metal material CNZh for 24 hours or more and 48 hours or less. The nanocomposite metal material CNZa as a third product is thus produced.

In the exothermic reaction treatment (Step S133₁), while the supply of hydrogen gas is maintained, the temperature is raised to, for example, 250° C. or more and 450° C. or less under vacuum conditions, and the MHE reaction between the nanocomposite metal material CNZa and hydrogen is performed. The nanocomposite metal material CNZe as a fourth product is thus produced.

After performing a predetermined number of cycles of these treatments, perform a refiring treatment in the atmosphere at a temperature of 300° C. or more and 600° C. or less for 120 hours or more and 180 hours or less on the nanocomposite metal material CNZe, for example (Step S134₁). The nanocomposite metal material CNZ₁ of the embodiment is thus produced.

A treatment of performing Step S1301 (Steps S131₁ to S133₁) for a predetermined number of cycles and further performing the treatment of Step S134₁ once may be referred to as a cycle treatment. The cycle treatment may be repeated a plurality of times.

When the cycle treatment is repeated n times, in the n-th cycle treatment, the heat treatment (Step S131n), the hydrogen occlusion treatment (Step S132n), and the exothermic reaction treatment (Step S133n) are repeated in this order until the number of times reaches a predetermined number (Step S130n). The number of times of performing these treatments may be one cycle or a plurality of cycles.

After performing a predetermined number of cycles of these treatments, perform a refiring treatment in the atmosphere at a temperature of 300° C. or more and 600° C. or less for 120 hours or more and 180 hours or less on the nanocomposite metal material CNZe, for example (Step S134n). The nanocomposite metal material CNZn of the embodiment is thus produced.

With that, the nanocomposite metal materials CNZ₁ .. . CNZn of the embodiment are produced.

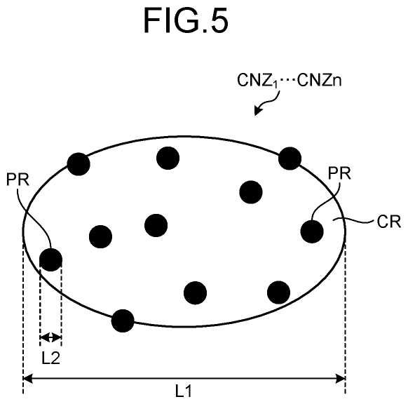

Next, a configuration example of the nanocomposite metal materials CNZ₁ . . . CNZn obtained by the production method of FIGS. 3 and 4 will be described. FIG. 5 is a schematic diagram illustrating an example of a configuration of the nanocomposite metal materials CNZ₁ . . . CNZn according to the embodiment.

As illustrated in FIG. 5, the nanocomposite metal materials CNZ₁ . . . CNZn of the embodiment includes a carrier CR and two-element metal particles PR supported on the carrier CR.

The carrier CR is zirconia (ZrO₂) ceramic having nano-sized pores inside and on the surface. The nanosize refers to, for example, a range of 2 nm or more and 50 nm or less. The outer shape of the carrier CR may be, for example, a spherical shape, an elliptical shape, a polygonal shape, or the like, and the shape is not particularly limited.

The two-element metal particles PR are supported in the pores inside and on the surface of the carrier CR. The state of being supported on the carrier CR means a state in which the two-element metal particles PR are adhered or fused to the inside and the surface of the carrier CR by chemical treatment such as firing. The state of being supported inside the carrier CR means being supported on the surface of the pores of the carrier CR.

The two-element metal particles PR are metal nanoparticles composed of two elements of copper (Cu) and nickel (Ni). More specifically, the two-element metal particles PR have a nanonickel core-copper shell structure with nickel as a core and copper as a shell. The outer shape of the two-element metal particles PR may be, for example, a spherical shape, an elliptical shape, a polygonal shape, a linear shape, a string shape in a state where at least a part is twisted, or the like, and the shape is not particularly limited.

The volume average particle diameter of the nanocomposite metal materials CNZ₁ . . . CNZn includes at least the range of 0.01 mm or more and 1 mm or less, preferably 0.05 mm or more and 0.5 mm or less, and more preferably 0.05 mm or more and 0.3 mm or less. Here, the volume average particle diameter of the carrier CR is defined as the volume average particle diameter of the nanocomposite metal materials CNZ₁ . . . CNZn, and it is, for example, the particle diameter L1 illustrated in FIG. 5.

The volume average particle diameter of the two-element metal particles PR is, for example, the particle diameter L2 illustrated in FIG. 5, and it is, for example, in the range of 2 nm or more and 50 nm or less, preferably in the range of 2 nm or more and 20 nm or less, and more preferably in the range of 2 nm or more and 10 nm or less.

More specifically, the volume average particle diameter of the nanocomposite metal materials CNZ₁ . . . CNZn and the two-element metal particles PR is measured as follows.

That is, an element distribution map is measured under the condition of 200 keV electron beam scanning using a product name: STEM/EDS manufactured by NEC Corporation as a measurement apparatus. Based on the measurement results thus obtained, the shape of each of the nanocomposite metal materials CNZ₁ . . . CNZn and the two-element metal particles PR is subjected to an image analysis with a resolution of 1 nm or less, whereby the volume average particle size may be measured.

The oxidation degree of zirconium (Zr) contained in the carrier CR of the nanocomposite metal materials CNZ1 CNZn is, for example, more than 31% and 100% or less, preferably 50% or more and 100% or less, more preferably 80% or more and 100% or less, and still more preferably 90% or more and 100% or less. The oxidation degree of zirconium (Zr) in the carrier CR may be adjusted by adjusting the firing temperature and the firing time in the firing treatment.

The oxidation degree is a ratio of the weight of the nanocomposite metal material CNZn after the firing treatment to the weight of the fine metal particles 63 before the firing treatment. Specifically, the firing treatment is performed at 450° C. for 120 hours or more and 180 hours or less. At this time, the weight increase rate of the nanocomposite metal material CNZc after the firing treatment with respect to the weight before the firing treatment is measured and taken as the oxidation degree which is the increase rate of the oxygen addition amount by the firing treatment.

As the composition of the nanocomposite metal materials CNZ₁ . . . CNZn, the atomic number ratio between copper and nickel (Cu:Ni) is, for example, in the range of 1:7 or more and 1:15 or less, and preferably in the range of 1:7 or more and 1:12 or less. The atomic number ratio between Ni and Zr is, for example, in the range of 1:2 or more and 1:4 or less, and preferably in the range of 1:2 or more and 1:3 or less.

The above composition in the nanocomposite metal materials CNZ₁ . . . CNZn is controlled by adjusting the atomic ratio (mass ratio) of the Cu—Ni—Zr alloy 61, which is the amount charged when the fine metal particles 63 are produced.

In this manner, the measurable physical amount shows substantially the same value in any of the nanocomposite metal materials CNZ₁ . . . CNZn. In the nanocomposite metal material CNZc obtained by firing the fine metal particles 63 illustrated in FIG. 3 and the nanocomposite metal material CNZe after the exothermic reaction treatment in the first cycle treatment and before the refiring treatment, the physical amounts are substantially the same value.

However, the nanocomposite metal material CNZe generates excessive heat higher than, for example, the heat generated by the nanocomposite metal material CNZc, by undergoing the heat treatment, the hydrogen occlusion treatment, and the exothermic reaction treatment. The nanocomposite metal material CNZ₁ generates excessive heat that is dramatically higher than, for example, the heat generated by the nanocomposite metal material CNZe, by undergoing the refiring treatment in addition to the heat treatment, the hydrogen occlusion treatment, and the exothermic reaction treatment. As the heat treatment, the hydrogen occlusion treatment, the exothermic reaction treatment, and the refiring treatment are repeated, that is, as the number of n of the nanocomposite metal material CNZn is increased by repeatedly performing the cycle treatment, the excessive heat obtained from the nanocomposite metal material CNZn tends to increase.

This mechanism has not been clarified in many respects, and there are also many unclear points at present regarding a measurement method and a physical amount with which the nanocomposite metal materials CNZc, CNZe, CNZ₁ . . . CNZn can be clearly distinguished. In view of this, the discussion by the inventors of the present invention at present will be described below.

First, when the fine metal particles 63 are produced, nickel is hardly oxidized by the oxidation treatment of the amorphous metal 62, but it is considered that at least part of copper is oxidized to form copper oxide. It is considered that by heating the nanocomposite metal material CNZc obtained by firing such fine metal particles 63 to cause the nanocomposite material to further occlude hydrogen gas, oxygen atoms contained in copper oxide in the nanocomposite metal material CNZc react with hydrogen gas, oxygen is discharged as water or heavy water, and holes are formed on the surface of the carrier CR because of separation of oxygen atoms.

When the nanocomposite metal material CNZa occluding hydrogen is heated in the subsequent exothermic reaction treatment, at least part of hydrogen occluded in the nanocomposite metal material CNZa is released as described above. At the time of this hydrogen releasing, it is considered that the two-element metal particles PR are supported on the carrier CR in a finely pulverized state, and the number of exothermic sites formed by hydrogen clusters on the surface of the incomplete core-shell structure increases.

More specifically, it is considered that a nanocatalyst dent structure is formed on the core surface of the incomplete core-shell structure with the releasing of some hydrogen. Such a nanocatalyst dent structure is called a subnanohole in a theoretical model.

It is considered that this can increase the excessive heat in the nanocomposite metal material CNZe.

It is considered that the number of such exothermic sites is further increased by combining the heat treatment, the hydrogen occlusion treatment, the exothermic reaction treatment, and the refiring treatment described above, and the exothermic reaction at the nickel core T sites, which induces internal hydrogen clusters due to phonon excitation caused under temperature rise in a state where the nickel core O-sites are filled with hydrogen, is greatly increased under a dynamic balance under the elevated temperature of hydrogen releasing and occlusion. Thus, it is considered that the excessive heat can be further increased in the nanocomposite metal material CNZ₁.

The number of heat generation sites can be further increased by repeating the cycle treatment of the heat treatment, the hydrogen occlusion treatment, the exothermic reaction treatment, and the refiring treatment. Thus, as the number of n of the nanocomposite metal material CNZn increases, the excessive heat can further increase.

As an example, in the nanocomposite metal material CNZ₁, excessive heat of 100 W/kg or more is obtained. In this case, the excessive heat is calculated, for example, by comparing with heat amount correction test data obtained when the same treatment is performed in the reactor 21 on a non-exothermic blank sample such as zirconia beads in the same amount as the sample SM.

For example, in the nanocomposite metal material CNZ₂ in which the above-described cycle treatment is repeated twice, excessive heat of 200 W/kg or more is obtained.

In the above example, the method for generating excessive heat of the embodiment is applied to the nanocomposite metal materials CNZ₁ . . . CNZn of the embodiment. However, although the calorific value decreases, the method for generating excessive heat of the embodiment may be applied to the nanocomposite metal materials CNZc, CNZe, and the like.

In the examples of FIGS. 3 to 5 described above, the carrier CR is zirconia (ZrO₂) ceramic, but the ceramic constituting the carrier CR is not limited thereto, and may be, for example, zirconium (Zr), zirconia (ZrO₂), mesoporous silica, zeolite, carbon nanotube, or the like.

### Conclusion

There is a technique to cause an exothermic reaction between a nanocomposite metal material and hydrogen. That is, when the temperature is raised after hydrogen gas is occluded in the nanocomposite metal material, an exothermic reaction called MHE reaction occurs. When a predetermined time elapses, the calorific value of the nanocomposite metal material decreases, and how to continue the MHE reaction for a long time is a problem. For example, it is conceivable to further heat the nanocomposite metal material with a heating body or the like provided in a reactor to increase the calorific value.

However, it is difficult to increase the calorific value again with the nanocomposite metal material in which the calorific value is reduced or heat is no longer generated being loaded in the reactor.

The exothermic reaction apparatus 100 of the embodiment controls the hydrogen occlusion rate of the nanocomposite metal material accommodated in the reactor 21 into the range of 1.0 or more and 3.5 or less by controlling the valve 15b to stop the supply of hydrogen into the reactor 21 when the hydrogen occlusion rate of the nanocomposite metal material approaches the predetermined value during the MHE reaction, and by controlling the valve 15b to resume the supply of hydrogen into the reactor 21 after a predetermined time.

In the MHE reaction between the nanocomposite metal material and hydrogen, when the hydrogen occlusion rate of the nanocomposite metal material is 1.0 or more and 3.5 or less, excessive heat close to the peak value can be obtained. By appropriately performing the reactivation treatment of the exothermic reaction by the opening and closing operation of the valve 15b as described above, the hydrogen occlusion rate of the nanocomposite metal material is controlled within the range of 1.0 or more and 3.5 or less, and excessive heat can be stably generated for a long period of time.

The exothermic reaction apparatus 100 of the embodiment controls the valve 15b to stop the supply of hydrogen into the reactor 21 when the hydrogen occlusion rate of the nanocomposite metal material becomes, for example, 1.0 or more and 3.5 or less, preferably 1.5 or more and 3.0 or less. By controlling the valve 15b based on the hydrogen occlusion rate of the nanocomposite metal material in this manner, the hydrogen occlusion rate of the nanocomposite metal material can be controlled into the range of 1.0 or more and 3.5 or less, and excessive heat can be stably generated for a long period of time.

The exothermic reaction apparatus 100 of the embodiment controls the valve 15b to resume the supply of hydrogen into the reactor 21 when the differential pressure between the pressure gauges 14a and 14b becomes 10 kPa or more and 200 kPa or less after the supply of hydrogen into the reactor 21 is stopped. By resuming the supply of hydrogen gas in a state where the pressure has reached the predetermined differential pressure in this manner, the occlusion of hydrogen gas in the nanocomposite metal material can be promoted. Thus, it is possible to reactivate the nanocomposite metal material in which the calorific value is reduced or heat is no longer generated, to activate the exothermic reaction again, and to increase the calorific value.

The method for generating excessive heat of the embodiment includes causing the nanocomposite metal materials CNZ₁ . . . CNZn to have an MHE reaction, the nanocomposite metal materials being produced by performing a firing treatment on the fine metal particles 63 obtained by pulverizing an amorphous metal containing Cu, Ni, and Zr to produce the nanocomposite metal material CNZc, and performing a cycle treatment one or more times, the cycle treatment being a treatment of performing one or more cycles of the heat treatment, the hydrogen occlusion treatment, and the exothermic reaction treatment and performing the refiring treatment once. By using such nanocomposite metal materials CNZ₁ . . . CNZn, the excessive heat obtained by the MHE reaction can be increased.

### EXAMPLES

Hereinafter, the present invention will be specifically described with reference to Examples, but the present invention is not limited to these Examples.

### Production of Sample

First, fine metal particles were produced as follows. The following fine metal particles are an example of the fine metal particles 63 in FIG. 2 described above.

A Cu—Ni—Zr alloy was melted by heating in a heating furnace, and the molten liquid was supplied to a rotating cooling roller. The molten liquid solidified by coming into contact with the rotating cooling roller to form a ribbon-shaped amorphous metal.

The amorphous metal was charged into a crucible and heated in the atmosphere at a temperature of 450° C. for 120 hours. The heated amorphous metal was pulverized with an automatic mortar, whereby fine metal particles were produced.

Next, a nanocomposite metal material was produced from the fine metal particles described above. The following nanocomposite metal material is an example of the nanocomposite metal material CNZ₂ in FIG. 2 described above.

The fine metal particles produced as described above were put into an electric furnace and fired at 450° C. for 120 hours in the atmosphere. A nanocomposite metal material was produced by this firing treatment. This nanocomposite metal material is an example of the nanocomposite metal material CNZc in FIG. 2 described above.

Next, the nanocomposite metal material produced as described above was supplied into an electric furnace. The inside of the electric furnace was brought into a vacuum state and heated for 24 hours to perform a heat treatment. Next, hydrogen gas was supplied while the inside of the electric furnace was maintained in a vacuum state to perform a hydrogen occlusion treatment. Then, after this state was maintained for 24 hours, the inside of the electric furnace was heated while the supply of hydrogen gas into the electric furnace was continued, the material temperature distribution in the electric furnace was controlled in a temperature range of at least 200° C. and at most 450° C. or less, and the exothermic reaction treatment was performed for several days.

The above-described heat treatment, hydrogen occlusion treatment, and exothermic reaction treatment were performed a predetermined number of times to produce a nanocomposite metal material. This nanocomposite metal material is an example of the nanocomposite metal material CNZe in FIG. 2 described above.

The nanocomposite metal material was put into an electric furnace and subjected to refiring at 450° C. for 120 hours in the atmosphere. A nanocomposite metal material was produced by this refiring treatment. This nanocomposite metal material is an example of the nanocomposite metal material CNZ₁ in FIG. 2 described above.

A cycle treatment of performing the above-described heat treatment, the hydrogen occlusion treatment, and the exothermic reaction treatment a predetermined number of times and performing the refiring treatment once was further performed once on the nanocomposite metal material produced as described to produce a nanocomposite metal material of Example corresponding to the nanocomposite metal material CNZ₂ in the embodiment described above.

### Excessive Heat Generation Test

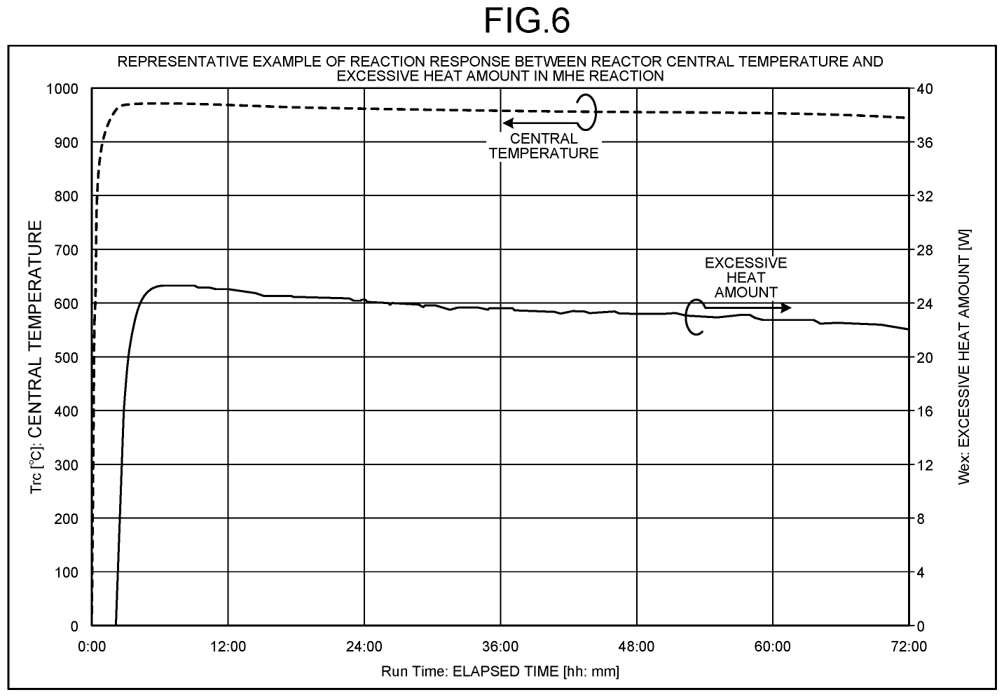

Next, the nanocomposite metal material produced as described above was supplied into an electric furnace as a sample, and subjected to the heat treatment, the hydrogen occlusion treatment, and the exothermic reaction treatment in the same manner as described above, and an excessive heat generation test was conducted. The results are illustrated in FIG. 6.

FIG. 6 is a graph illustrating a representative example of a reaction response between a reactor central temperature and an excessive heat amount in an MHE reaction according to Example. The horizontal axis of the graph represents the elapsed time (hh:mm). The vertical axis on the left side of the graph represents the central temperature Trc (° C.) of the sample, and the vertical axis on the right side of the graph represents the excessive heat amount Wex (W) per unit time.

For the excessive heat generation test, the same apparatus as the exothermic reaction apparatus 100 of the embodiment described above was used. The capacity of the reactor of the exothermic reaction apparatus was about 0.4 L, and the capacity of the hydrogen supply source serving as a hydrogen gas supply source was about 7.7 L.

The excessive heat amount obtained from the sample was calculated by comparing a measurement value of a temperature sensor provided in an electric furnace and capable of measuring the temperature of the central part of the sample with heat amount correction test data. The heat amount correction test data is a measurement value of a temperature sensor for a non-exothermic blank sample of zirconia beads in the same amount as the sample.

As illustrated in FIG. 6, when the central temperature of the sample is increased in the electric furnace, the excessive heat amount also rapidly increases within an elapsed time of 2 hours to 3 hours, then reaches a peak of the excessive heat amount when the elapsed time reaches about 5 hours. Thereafter, both the central temperature and the excessive heat amount of the sample show stable values. In this manner, there was a correlation between the central temperature of the sample and the excessive heat amount except for the very early stage of the MHE reaction.

### Reactivation Test

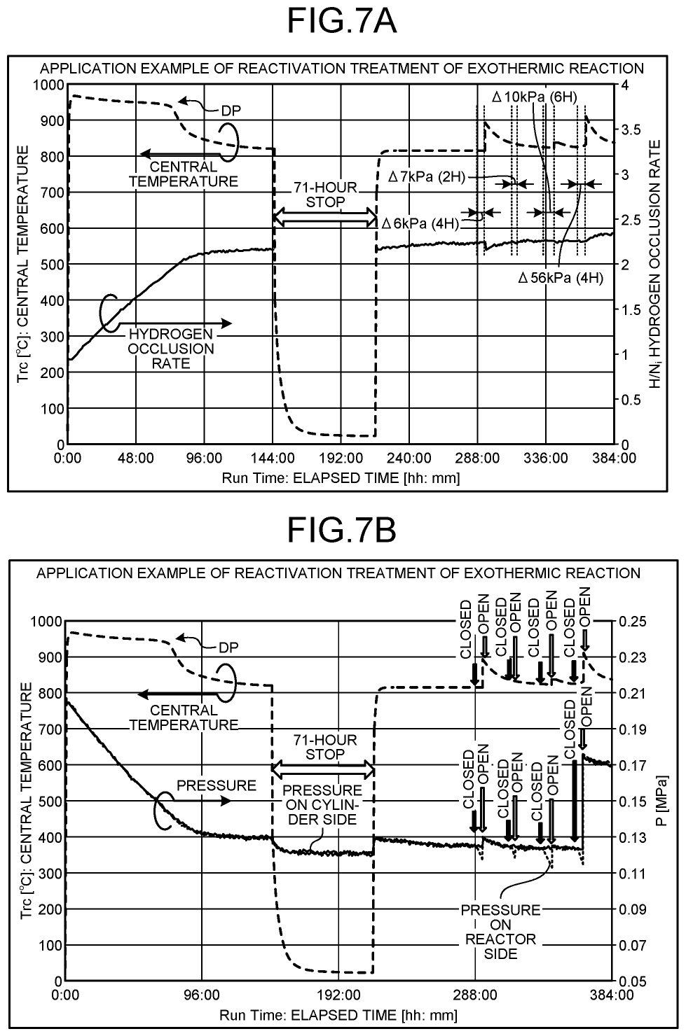

Subsequently, the above-described excessive heat generation test was continued, and during that time, the reactivation treatment of the exothermic reaction was applied. That is, during the exothermic reaction treatment in the excessive heat generation test, the reactivation treatment of the exothermic reaction was intermittently performed a plurality of times. The results are illustrated in FIGS. 7A and 7B.

FIGS. 7A and 7B are graphs illustrating an application example of the reactivation treatment of the exothermic reaction according to Example.

The horizontal axis of the graph of FIG. 7A represents the elapsed time (hh:mm). The vertical axis on the left side of the graph represents the central temperature Trc (° C.) of the sample, and the vertical axis on the right side of the graph represents the hydrogen occlusion rate (H/Ni) in the sample.

The horizontal axis of the graph of FIG. 7B represents the elapsed time (hh:mm). The vertical axis on the left side of the graph represents the central temperature Trc (° C.) of the sample, and the vertical axis on the right side of the graph represents the pressure P (MPa) on the hydrogen supply source side and the pressure P (MPa) on the reactor side.

During the exothermic reaction treatment, the input power to the heating bodies provided to the reactor was set to 160 W. However, the heating of the sample was temporarily stopped and the MHE reaction was interrupted for 71 hours of the elapsed time of 144 hours to 215 hours. Thus, data during this period is not referred to.

As illustrated in FIG. 7A, the hydrogen occlusion rate in the sample that was less than 1.0 at the initial stage of the temperature rise increases as the temperature rise progresses, and when the occlusion rate becomes 1.0 or more, excessive heat due to the MHE reaction is rapidly generated, and the central temperature of the sample rises to near 1000° C. According to the example of FIG. 6 described above, it is considered that when the central temperature of the sample exceeds 900° C., an excessive amount of heat of about 24 W per unit time is stably obtained.

Thereafter, around the time when the hydrogen occlusion rate exceeds 2.0, the increase in the occlusion rate stops and becomes substantially flat. It is considered that the central temperature of the sample maintained at 900° C. or more accordingly decreases to near 800° C. with the point DP as a boundary, and the excessive heat amount per unit time also decreases.

Thus, after the elapse of 288 hours, the reactivation treatment of the exothermic reaction was intermittently performed a plurality of times.

As illustrated in FIG. 7B, when the elapsed time reached 288 hours, the valve to cut off the hydrogen supply line from the reactor was closed, and after an elapse of a predetermined time, the valve was opened again. During a period from when the valve was closed to when the valve was opened, the pressure P on the hydrogen supply source side was maintained substantially constant, and the pressure P on the reactor side decreased because hydrogen gas was continuously occluded in the sample.

After an elapsed time of one day from the opening of the valve, the valve was closed again, and after the elapse of a predetermined time, the valve was opened. After the elapse of further one day, the valve was closed, and after the elapse of a predetermined time, the valve was opened. The operation of opening and closing the valve once a day was repeated four times in this manner.

As illustrated in FIG. 7A, in the first opening and closing operation of the valve, the valve was opened again 4 hours after the valve was closed. At that time, the differential pressure between the hydrogen supply source side and the reactor side was 6 kPa. In conjunction with such an opening and closing operation of the valve, the hydrogen occlusion rate in the sample increases and the central temperature of the sample increases after the valve is opened. It is considered that the excessive heat amount per unit time also increased accordingly.

In the second opening and closing operation of the valve, the valve was opened again 2 hours after the valve was closed. At that time, the differential pressure between the hydrogen supply source side and the reactor side was 7 kPa. However, at this time, noticeable change was not observed in the hydrogen occlusion rate in the sample or the central temperature of the sample. From this, it is found that the timing of opening the valve is preferably when the differential pressure between the hydrogen supply source side and the reactor side is 10 kPa or more, and more preferably 20 kPa or more.

In the third opening and closing operation of the valve, the valve was opened again 6 hours after the valve was closed. At that time, the differential pressure between the hydrogen supply source side and the reactor side was 10 kPa. Also at this time, after the valve is opened, the hydrogen occlusion rate in the sample increases, and the central temperature of the sample increases. It is considered that the excessive heat amount per unit time also increased accordingly.

In the fourth opening and closing operation of the valve, the valve was opened again 4 hours after the valve was closed. At that time, the differential pressure between the hydrogen supply source side and the reactor side was 56 kPa. Also at this time, after the valve is opened, the hydrogen occlusion rate in the sample increases, and the central temperature of the sample increases. It is considered that the excessive heat amount per unit time also increased accordingly.

It has been found that even after the hydrogen occlusion rate in the sample approaches a predetermined value and the generation of excessive heat is reduced, the sample is reactivated by appropriately performing the reactivation treatment of the exothermic reaction to promote the generation of excessive heat, and the MHE reaction can be continued in this manner.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An exothermic reaction apparatus that makes an exothermic reaction by supplying hydrogen to a nanocomposite metal material including a carrier made of ceramic and two-element metal particles supported on the carrier and containing Cu and Ni, the exothermic reaction apparatus comprising:
a reactor capable of accommodating the nanocomposite metal material;
a plurality of heating bodies that heat the nanocomposite metal material accommodated in the reactor;
an exhaust unit that exhausts an inside of the reactor;
a gas pipe having an upstream end connected to a hydrogen supply source and a downstream end connected to the reactor to supply hydrogen to the reactor;
a cutoff unit provided in the gas pipe to cut off the supply of hydrogen to the reactor;
a measurement unit that measures an occlusion rate of hydrogen in the nanocomposite metal material accommodated in the reactor; and
a controller that controls the exothermic reaction apparatus,
wherein the controller controls the occlusion rate of hydrogen in the nanocomposite metal material accommodated in the reactor to a value within a range of 1.0 or more and 3.5 or less by controlling the cutoff unit during the exothermic reaction to stop the supply of hydrogen into the reactor when the occlusion rate of hydrogen in the nanocomposite metal material based on a measurement result obtained with the measurement unit approaches a predetermined value and to resume the supply of hydrogen into the reactor a predetermined time after.

2. The exothermic reaction apparatus according to claim 1, wherein
the controller controls the cutoff unit to stop the supply of hydrogen into the reactor in a state where the occlusion rate based on the measurement result obtained with the measurement unit is 1.0 or more and 3.5 or less.

3. The exothermic reaction apparatus according to claim 1, wherein
the controller controls the cutoff unit to stop the supply of hydrogen into the reactor in a state where the occlusion rate based on the measurement result obtained with the measurement unit is 1.5 or more and 3.0 or less.

4. The exothermic reaction apparatus according to claim 1, wherein
the measurement unit includes:
a first pressure gauge provided in the gas pipe upstream of the cutoff unit; and
a second pressure gauge provided in the gas pipe downstream of the cutoff unit,
wherein after the supply of hydrogen into the reactor is stopped, the controller controls the cutoff unit to resume the supply of hydrogen into the reactor in a state where a differential pressure between the first and second pressure gauges is 5 kPa or more and 200 kPa or less.

5. The exothermic reaction apparatus according to claim 1, wherein
the carrier is made of zirconia ceramic having an oxidation degree of more than 31% and 100% or less, and
the nanocomposite metal material is a nanocomposite metal material having an excessive heat of 100 W/kg or more when the nanocomposite metal material is supplied with at least one of hydrogen gas or deuterium gas in a vacuum state and heated at a temperature of 250° C. or more and 350° C. or less, the excessive heat being calculated by comparing with heat amount correction test data of a non-exothermic blank sample of zirconia beads.

6. A method for generating excessive heat, the method comprising:
making an exothermic reaction by supplying hydrogen to a nanocomposite metal material including a carrier made of ceramic and two-element metal particles supported on the carrier and containing Cu and Ni, and
controlling an occlusion rate of hydrogen in the nanocomposite metal material to a value within a range of 1.0 or more and 3.5 or less during the exothermic reaction by stopping the supply of hydrogen to the nanocomposite metal material when the occlusion rate of hydrogen in the nanocomposite metal material approaches a predetermined value and resuming the supply of hydrogen to the nanocomposite metal material a predetermined time after.

7. The method for generating excessive heat according to claim 6, wherein
the controlling the occlusion rate includes stopping the supply of hydrogen to the nanocomposite metal material in a state where the occlusion rate is 1.0 or more and 3.5 or less.

8. The method for generating excessive heat according to claim 6, wherein
the controlling the occlusion rate includes stopping the supply of hydrogen to the nanocomposite metal material in a state where the occlusion rate is 1.5 or more and 3.0 or less.

9. The method for generating excessive heat according to claim 6, wherein
the controlling the occlusion rate includes
monitoring a first, hydrogen-supply-source-side pressure that supplies hydrogen to the nanocomposite metal material and a second, nanocomposite-metal-material-side pressure after the supply of hydrogen to the nanocomposite metal material is stopped; and
resuming the supply of hydrogen to the nanocomposite metal material in a state where a differential pressure between the first and second pressures is 5 kPa or more and 200 kPa or less.

10. The method for generating excessive heat according to claim 6, the method comprising:
a firing treatment of firing fine metal particles obtained by pulverizing an amorphous metal containing Cu, Ni, and Zr at a temperature of 300° C. or more and 600° C. or less in the atmosphere to produce a first product;
a heat treatment of heating the first product at a temperature of 200° C. or more and 450° C. or less in vacuum to produce a second product;
a hydrogen occlusion treatment of supplying at least one of hydrogen gas or deuterium gas to the second product in vacuum and causing the second product to occlude the at least one of hydrogen or deuterium to produce a third product;
an exothermic reaction treatment of heating the third product at a temperature of 200° C. or more and 450° C. or less in vacuum and causing an exothermic reaction to produce a fourth product; and
a refiring treatment of refiring the fourth product at a temperature of 300° C. or more and 600° C. or less in the atmosphere,
the method including producing the nanocomposite metal material by performing a cycle treatment one or more times, the cycle treatment being a treatment of performing one or more cycles of the heat treatment, the hydrogen occlusion treatment, and the exothermic reaction treatment and performing the refiring treatment once.
